(19) United States
(12) Patent Application Publication
(10) Pub. No.: US 2012/0229118 A1
(43) Pub. Date: Sep. 13, 2012

(54) REACTOR AND POWER CONVERTER USING THE SAME

(75) Inventors: Naoyuki KURITA, Hitachi (JP); Kenichi ONDA, Hitachi (JP)

(73) Assignee: HITACHI, LTD., Tokyo (JP)

(21) Appl. No.: 13/396,080

(22) Filed: Feb. 14, 2012

(30) Foreign Application Priority Data
Mar. 8, 2011 (JP) 2011-049864

(51) Int. Cl. H02J 3/00; H01F 17/06

(52) U.S. Cl. 323/362; 336/178

(57) ABSTRACT

A reactor includes a ringed core and a magnetic excitation coil. The ringed core includes a plurality of core blocks made of a magnetic material which are connected in a ring through gaps. The magnetic excitation coil is wound around the ringed core. The ringed core has a magnetic leg region around which the magnetic excitation coil is wound and a yoke portion region where the magnetic excitation coil is not wound. A length of the gap in the magnetic leg region is smaller than a length of the gap in the yoke portion region. Positions of gaps or magnetic excitation coil may be modified. A power converter using the reactor is also disclosed.

### CROSS REFERENCE TO RELATED APPLICATION

This application claims the foreign priority benefit under Title 35, United States Code, §119(a)-(d) of Japanese Patent Application No. 2011-049864, filed on Mar. 8, 2011 in the Japan Patent Office, the disclosure of which is herein incorporated by reference in its entirety.

### BACKGROUND OF THE INVENTION

1. Field of the Invention

The present invention relates to a reactor and a power converter using the same and particularly to a reactor including a ringed core made of a magnetic material and a magnetic excitation coil wound around the core and a power converter using the same.

2. Description of the Related Art

Reactors generally include a ringed core made of a magnetic material and a magnetic excitation coil wound around the ringed core. In the reactor, magnetic flux is generated in the ringed core when the magnetic excitation coil is electrically conducted. JP 2009-259971 and JP 2008-263062 disclose that gaps are formed in the ringed core under coils to make a magnetic density converged within a region of a saturation magnetic density inherent in the magnetic material of the ringed core.

In the reactors disclosed in JP 2009-259971 and JP 2008-263062, the gaps are formed in a region where the magnetic excitation coil is wound around the ringed core. In this case, a part of the magnetic flux passing through the ringed core leaks from gaps, and the leakage flux is interlinked with the magnetic excitation coil wound around the ringed core, which induces eddy currents. This generates heat called Joule heat, which may cause a loss in the reactor.

### SUMMARY OF THE INVENTION

The present invention may provide a reactor in which a loss caused by leakage of the magnetic flux from the gaps is suppressed though the ringed core has gaps at a region where the magnetic excitation coil is wound and a power converter using the reactor.

A first aspect of the present invention provides a reactor comprising:

a ringed core including a plurality of core blocks made of a magnetic material, the core blocks being connected in a ring through gaps;

a magnetic excitation coil wound around the ringed core, wherein the ringed core comprises a magnetic leg region around which the magnetic excitation coil is wound and a yoke portion region where the magnetic excitation coil is not wound, and wherein a length of the gap between end faces of adjoining core blocks in the magnetic leg region is smaller than a length of the gap between end faces of adjoining core blocks in the yoke portion region.

A second aspect of the present invention provides a power converter comprising:

a filter circuit connected to an AC power source, the filter circuit including the reactor described in the first aspect and a capacitor; and

a switching circuit configured to perform switching of an output of the filter circuit to generate a power conversion output.

### BRIEF DESCRIPTION OF THE DRAWINGS

The object and features of the present invention will become more readily apparent from the following detailed description taken in conjunction with the accompanying drawings in which:

FIG. 1A is a perspective view of a whole of a reactor according to a first embodiment of the present invention;

FIG. 1B is a front cross section view of the reactor according to the first embodiment of the present invention;

FIG. 2 is a front section view of a reactor according to a second embodiment of the present invention;

FIG. 3 is a front section view of a reactor according to a third embodiment of the present invention;

FIG. 4 is a front section view of a reactor according to a fourth embodiment of the present invention;

FIG. 5 is a front section view of a reactor according to a fifth embodiment of the present invention to show a fixing configuration of the reactor;

FIG. 6 is a schematic circuit diagram of a power converter according to a sixth embodiment of the present invention;

FIG. 7 is a schematic circuit diagram of a power converter according to a seventh embodiment of the present invention;

FIG. 8 is a cross section of an example of a conductor according to the first to sixth embodiments of the present invention; and

FIG. 9 is a cross section of an example of another conductor according to the first to sixth embodiments of the present invention.

The same or corresponding elements or parts are designated with like references throughout the drawings.

### DETAILED DESCRIPTION OF THE INVENTION

With reference to drawings in detail will be described embodiments of the present invention.

### First Embodiment

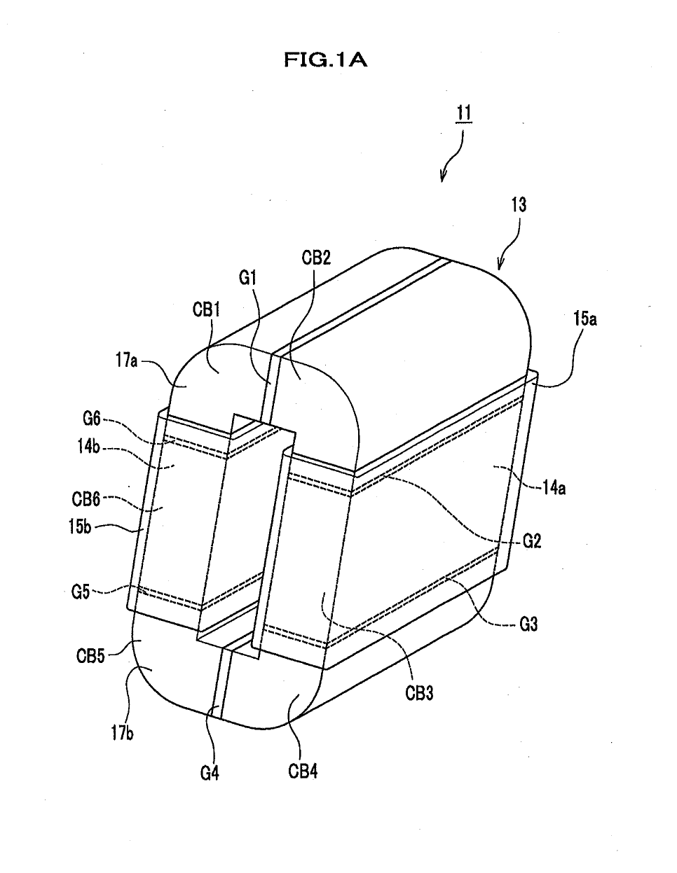

FIG. 1A shows a perspective view of a reactor according to a first embodiment of the present invention. FIG. 1B is a front cross section view of the reactor according to the first embodiment of the present invention.

A reactor 11 according to the first embodiment is configured so as to suppress a loss in the reactor 11 caused by leakage of the magnetic flux from gaps G2, G3, G5, G6 even if the gaps G2, G3, G5, G6 are formed within a region where the magnetic excitation coil 15 is wound around a ringed core 13.

As shown in FIGS. 1A and 1B, the reactor according to the first embodiment includes the ringed core 13 and magnetic excitation coils 15a and 15b wound around parts of the ringed core 13. The ringed core 13 is formed with soft magnetic materials in thin plates 6 which are laminated. More preferably, an isotropic material formed in thin plates may be used. The soft magnetic material is a material having a soft magnetic characteristic (a characteristic of being easily magnetized when magnetic field is applied from the outside). For example, a silicon steel sheet, an electrical steel plate, and an amorphous film of which main component is iron, can be used.

As shown in FIGS. 1A and 1B, the ringed core 13 is formed in a substantially rectangular of which four corners when viewed from a front thereof, are chamfered. A direction of the magnetic flux passing through the ringed core 13 when a single phase AC power source is connected to the excitation coil 15b is shown with an arrow B in FIG. 1B. A lamination direction of the soft magnetic materials is orthogonal with the direction B of the magnetic flux.

The ringed core 13 includes first to sixth core blocks connected in a ring as shown in FIGS. 1A and 1B through gaps (gap spacers), i.e., with intervention by the gaps. Each of the first to sixth core blocks CB1 to CB6 are made of a soft magnetic material. Between each pair of adjoining core blocks in the first to sixth core blocks CB1 to CB6 first to sixth gaps G1 to G6 are formed.

Here, positions of the gaps G1 to G6 are expressed using a clock face notation in the front view of the rectangular frame shape of the ringed core 13. The first gap G1 is located at a position of 12 o'clock and vertically extends at a middle of a top portion of the annular shape of the ringed core 13 in FIG. 1B. The forth gap G4 is located at a position of 6 o'clock and vertically extends at a middle of a bottom portion of the annular shape of the ringed core 13 in FIG. 1B. The second and third gaps G2 and G3 are located at positions just after and before 3 o'clock in the vertically extending part of the ringed core 13 with an interval therebetween and extend horizontally. Accordingly, the ringed core 13 is formed in a ring with the first to sixth core blocks to have a rounded rectangular frame shape in the front view thereof.

The ringed core 13 includes first and second magnetic leg portions 14a and 14b facing each other across a through hole of the ringed core 13 as shown in FIGS. 1A and 1B. Around the first magnetic leg portion 14a, a first magnetic excitation coil 15a is wound, and around the second magnetic leg portion 14b, a second magnetic excitation coil 15b is wound. The ringed core 13 includes the first magnetic leg portion 14a in a region where the first magnetic excitation coil 15a is wound around the ringed core 13 and the second magnetic leg portion 14b in a region where the second magnetic excitation coil 15b is wound around the ringed core 13.

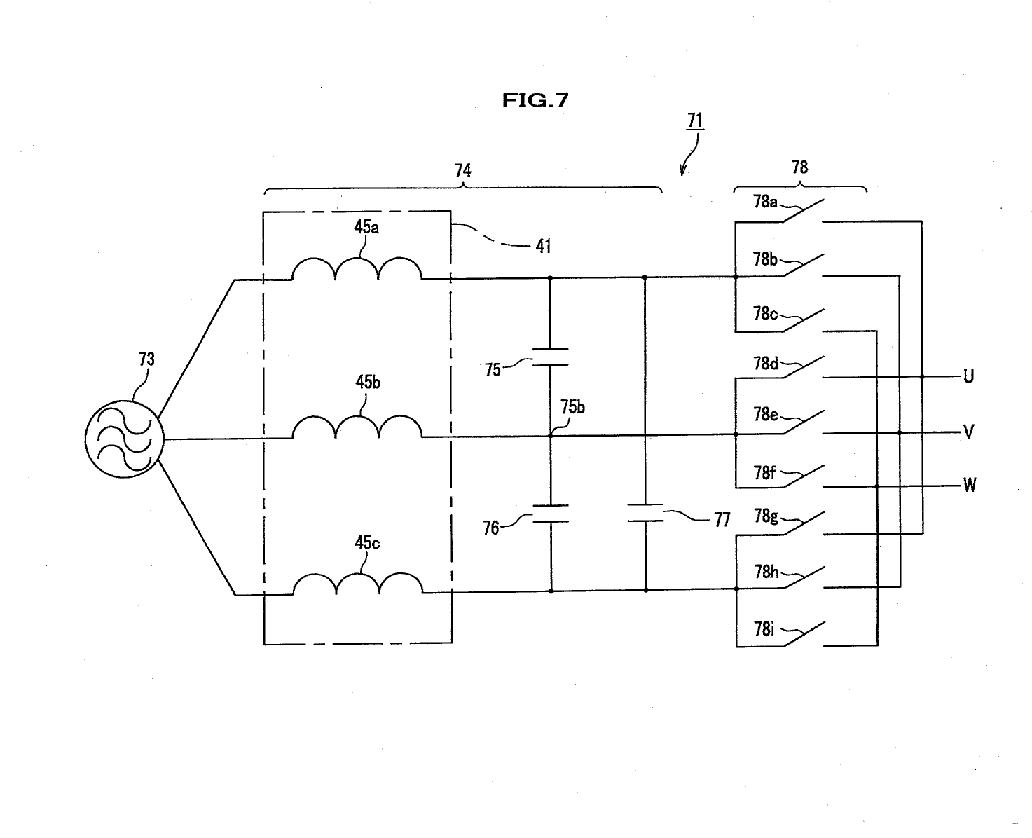

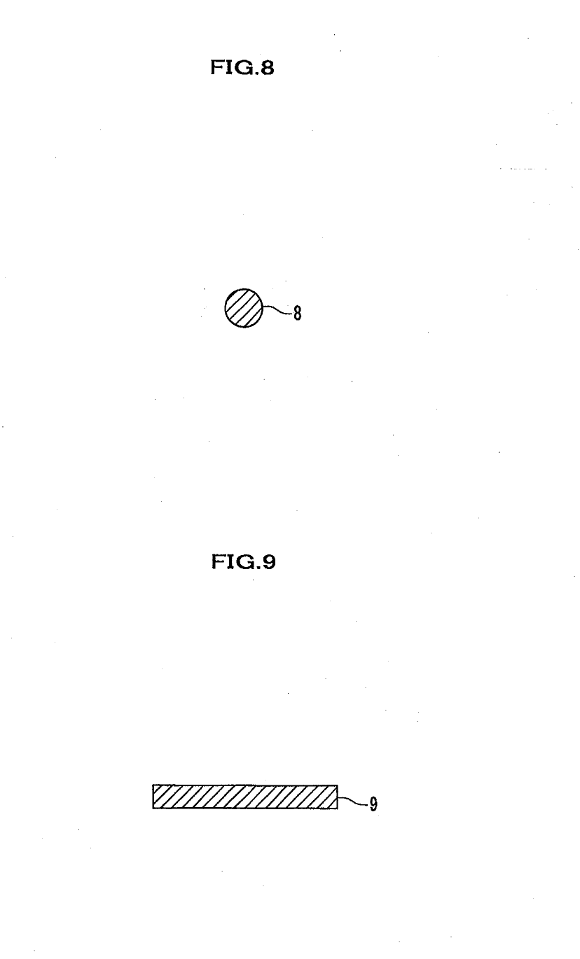

Each of the first and second magnetic excitation coils 15a and 15b comprises a wire conductor 8 having a circular cross sectional shape as shown in FIG. 8 or a stripe plate conductor 9 having a rectangular cross sectional shape as shown in FIG. 9. When a current density flowing through this conductor is large, it is more preferable to use the stripe plate conductor 9. This is because the stripe plate conductor 9 can more suppress a loss due to Joule heat than the wire conductor. These conductors have an insulation material (not shown). More specifically, the insulation material is provided between the wire conductors 8 or the stripe conductors 9. This provides the first and second magnetic excitation coils 15a and 15b with good insulation property.

The first and second magnetic excitation coils 15a and 15b may be connected in parallel with each other to form an inductance circuit. In place of the parallel connection, the first and second magnetic excitation coils 15a and 15b may be connected in series to form an inductance circuit. For the parallel connection, the first and second magnetic excitation coils 15a and 15b respectively have a pair of electrode 19a and 19b, i.e., four electrodes in total are provided. For the serial connection, the first and second magnetic excitation coils 15a and 15b have a pair of electrodes.

Here, the magnetic leg portion is a portion of the ringed core 13 in a region where the magnetic excitation coils 15 (first and second magnetic excitation coils 15a and 15b) are wound (magnetic leg region). Accordingly, there may be a case where a border of the magnetic leg portion does not correspond to that of the core blocks CB1 to CB6 one by one. In the first embodiment, the first magnetic leg portion 14a corresponds to a region of the ringed core 13 including all of the third core block CB3 as well as parts of the second and fourth core blocks CB2, CB4. The second magnetic leg portion 14b corresponds to a region of the ringed core 13 including all the sixth core block CB6 as well as parts of the second and fourth core blocks CB1, CB5.

In addition, the ringed core 13 includes, as shown in FIGS. 1A and 1B, first and second yoke portions 17a and 17b facing each other across the through hole of the ringed core 13. The first or second magnetic excitation coil 15a or 15b is wound around neither of the first and second yoke portions 17a and 17b. In other words, the ringed core 13 has the first and second yoke portions 17a and 17b around which the first and second magnetic excitation coils 15a and 15b are not wound.

Here, “yoke portion” is a region of the ringed core 13 around which the magnetic excitation coils 15 (first and second magnetic excitation coils 15a and 15b) are not wound (yoke region). Accordingly, there is a case where a border “yoke portion” does not correspond to that of the core blocks CB. In the first embodiment, the first yoke portion 17a corresponds to a region of the ringed core 13 including a most part of the first and second core blocks CB1 and CB2. On the other hand, the second yoke portion 17b corresponds to a region of the ringed core 13 including a most part of the fourth and fifth core blocks CB4 and CB5.

In the first to sixth gaps G1 to G6, as shown in FIG. 1B, first to sixth gap spacers S1 to S6 are respectively installed. The gap spacers S1 to S6 are formed in plates and made of a non-magnetic material such as glass-epoxy plastic, ceramics such as alumina, a silicone rubber, or a plastic having a high heat resistivity. Each of the gap spacers has a size, particularly a thickness, corresponding to a length of the gap into which the gap spacer fits. This configuration provides control in upper limit in a magnetic flux density in the ringed core 13 by inserting the gap spacers S1 to S6 in the first and sixth gaps G1 to G6.

As shown in FIG. 1B, the first magnetic excitation coil 15a is connected to a pair of first electrodes 19a, and the second magnetic excitation coil 15b is connected to a pair of first electrodes 19b. When the first and second magnetic excitation coils 15a and 15b are electrically conducted with, for example, a single phase AC power source through the first and second electrodes 19a and 19b respectively, the ringed core 13 generates magnetic flux in the ringed core 13 in a direction B in FIG. 1B.

The first to sixth gaps G1 to G6 serve to control a density of magnetic flux generated by conduction of the first and second magnetic excitation coils 15a and 15b within a saturation magnetic flux density of the soft magnetic material which is a material of the ringed core 13. To control the magnetic flux density, a total gap length of the ringed core 13 is determined in accordance with various factors such as a kind of the material of the ringed core 13, the number of turns of the first and second magnetic excitation coils 15a and 15b, and a maximum rated power of the AC power source to be connected. This is because it is necessary to strictly control the upper limit of the magnetic flux density in the ringed core 13 to keep the magnetic flux density within the saturation magnetic flux density of the ringed core 13.

In manufacturing the reactor 11 according to the first embodiment for a large power use, for example, the first to sixth core blocks CB1 to CB6 and the first and second magnetic excitation coils 15a and 15b which are prepared by different processes. During a process of joining the first to sixth core blocks CB1 to CB6, the first and second magnetic excitation coils 15a and 15b are inserted through a pair of open ends of one part of the ringed core 13 under manufacturing. After that, a remaining core block is connected to the open-ends of the ringed core 13 having U-shape of the ringed core 13 under manufacturing. Then, this assembling sequence finishes. As a result of the assembling process, in the region just under the first and second magnetic excitation coils 15a and 15b, second to sixth gaps G2, G3, G5, and G6 are formed.

In other words, the first to sixth gaps G1 to G6 also serve to assist manufacturing the reactor 11 according to the first embodiment. To manufacture the reactor 11 according to the first embodiment, an inserting process of the first and second magnetic excitation coils 15a and 15b into the ringed core 13 through open-ends remaining in a half-finished part. To provide this process, the first to sixth gaps G1 to G6 are necessary for dividing the ringed core 13 at appropriate locations.

In the ringed core 13 of the reactor 11 according to the first embodiment, the first magnetic leg portion 14a has the second and the third gaps G2 and G3 and the second magnetic leg portion 14b has the fifth and sixth gaps G5 and G6, i.e., four gaps in total. Magnetic flux externally leaked from the gaps G2, G3, G5, and G6 is interlinked with the first and second magnetic excitation coils 15a and 15b and induces eddy currents in the first and second magnetic excitation coils 15a and 15b. If no countermeasure is made, an eddy current loss is generated in the first and second magnetic excitation coils 15a and 15b, which may cause to increase loss in the reactor.

Then the ringed core 13 of the reactor 11 according to the first embodiment has the first gap G1 in the first yoke portion 17a, and the fourth gap G4 in the second yoke portions 17b, i.e., four gaps in total. Accordingly, there is no magnetic excitation coil 15 around the first and fourth gaps G1 and G4. Then, no leakage flux from the first and fourth gaps is interlinked with the magnetic excitation coil 15, so that no eddy current is generated.

To simplify the description of the reactor 11 according to the first embodiment, assumption is made as follows:

As shown in FIG. 1B, a distance between end faces of the first and second core blocks CB1 and CB2 though the first gap G1 in the first yoke portion 17a is referred to as a first yoke portion gap length D_{G1}. A distance between end faces of the fourth and fifth core blocks CB4 and CB5 through the fourth gap G4 in the second yoke portion 17b is referred to as a fourth yoke portion gap length D_{G4}. On the other hand, a distance between end faces of the second and third core blocks CB2 and CB3 through the second gap G2 in the first magnetic leg portion 14a is referred to as a second magnetic leg portion gap length D_{G2}. A distance between end faces of the third and fourth core blocks CB3 and CB4 through the third gap G3 in the first magnetic leg portion 14a is referred to as a third magnetic leg portion gap length D_{G3}. A distance between end faces of the fifth and sixth core blocks CB5 and CB6 through the third gap G5 in the second magnetic leg portion 14b is referred to as a fifth magnetic leg portion gap length D_{G5}. A distance between end faces of the sixth and first core blocks CB6 and CB1 through the third gap G6 in the second magnetic leg portion 14b is referred to as a sixth magnetic leg portion gap length D_{G6}.

In the first embodiment of the present invention, as shown in FIG. 1B, the second or the third magnetic leg portion gap length D_{G2} or D_{G3} is set to be smaller than the first or fourth yoke portion gap length D_{G1} or D_{G4}. More specifically, the second and the third magnetic leg portion gaps D_{G2} and D_{G3} are set to the same value. Similarly, the first and the fourth magnetic leg portion gaps D_{G1} and D_{G4} are set to the same value. The second or third magnetic leg portion gap length D_{G2} or D_{G3} is smaller than a half of the first or fourth yoke portion gap length D_{G1} or D_{G4} (preferably, the value is set to a half, more preferably one third, further preferably one fourth thereof, or still further smaller). In other words, a total of the second and third magnetic leg portion gap lengths D_{G2} and D_{G3}, i.e., a magnetic leg portion gap length D_{G2}+D_{G3}, is set to be equal to or smaller than the first or the fourth yoke portion gap length D_{G1} or D_{G4}.

Similarly, as shown in FIG. 1B, the fifth or the sixth magnetic leg gap length D_{G5} or D_{G6} is set to be smaller than the first yoke portion gap length D_{G1} or the fourth yoke portion gap length D_{G4}. More specifically, the fifth and sixth magnetic leg portion gap lengths D_{G5}, D_{G6} are set to the same value. In addition, the fifth and sixth magnetic leg portion gap lengths D_{G5}, D_{G6} are set to the same value as the second and third magnetic leg portion gap lengths D_{G2}, D_{G3}.

A magnetic leg portion gap length D_{G5}+D_{G6} which is a total of the fifth and sixth magnetic leg gap lengths D_{G5}, D_{G6}, is set to be equal to or smaller than the first yoke portion gap length D_{G1} or the fourth yoke portion gap length D_{G4} (preferably, a half of, or more preferably one third of the first yoke portion gap length D_{G1} or the fourth yoke portion gap length D_{G4} or further small).

It is supposed that the second magnetic leg portion gap length D_{G2} is set to be larger than first or the fourth yoke portion gap length D_{G1} or D_{G4}. In this case, the magnetic flux leaked outside from the end faces of the core blocks CB2, CB3 adjoining each other through the second gap G2 is greater in magnitude than that from the first or the fourth yoke portion gap G1 or G4. As a result, this increases eddy currents induced in the first and second magnetic excitation coils 15a and 15b, which increases the loss of the reactor 11.

In summary, in the reactor 11 according to the first embodiment, the first and fourth gaps G1, G4 are respectively provided in the first and second yoke portions 17a, 17b which is a region of the ringed core 13 where the first and second magnetic excitation coils 15a and 15b are not wound. In addition, the second, third, fifth and sixth gaps G2, G3, G5, G6 are respectively provided in the first and second magnetic leg portions 14a, 14b which are regions of the ringed core 13 where the first and second magnetic excitation coils 15a and 15b are wound. The magnetic leg portion gap lengths D_{G2}, D_{G3}, D_{G5}, D_{G6} are set to smaller values than the first or fourth yoke portion gap length D_{G1} or D_{G4}.

More specifically, in the reactor 11 according to the first embodiment of the present invention, the magnetic leg portion gap lengths D_{G2}, D_{G3}, D_{G5}, D_{G6} are set to be smaller than usual values as well as the second, third, fifth, and sixth magnetic leg gap lengths D_{G2}, D_{G3}, D_{G5}, D_{G6} are set to be larger than usual values. Accordingly, the lack amount of the second, third, fifth, and sixth magnetic leg gap lengths D_{G2}, D_{G3}, D_{G5}, D_{G6} are covered by increase in the first and fourth yoke portion gap lengths D_{G1}, D_{G4} to keep a total amount of the gap length in the ringed core 13.

In addition, the magnetic leg gap lengths D_{G2}, D_{G3}, D_{G5}, D_{G6} are set to be smaller than the first or fourth yoke portion gap lengths D_{G1} or D_{G4}, which causes to decrease the leakage flux (gap loss) leaked to the external of the ringed core 13 from the gaps G2, G3, G5, G6. As a result, the eddy currents induced in the first and second magnetic excitation coils 15a and 15b can be reduced. Therefore, while a total gap length in the whole of the ringed core 13 is kept, the leakage flux (gap loss) from the second, the third, the fifth and sixth gaps G2, G3, G5, G6 in the first or second magnetic legs 14a, 14b can be suppressed. Accordingly, there is provided a single-phase reactor 11 of which loss in the whole of the reactor 11 can be suppressed.

### Second Embodiment

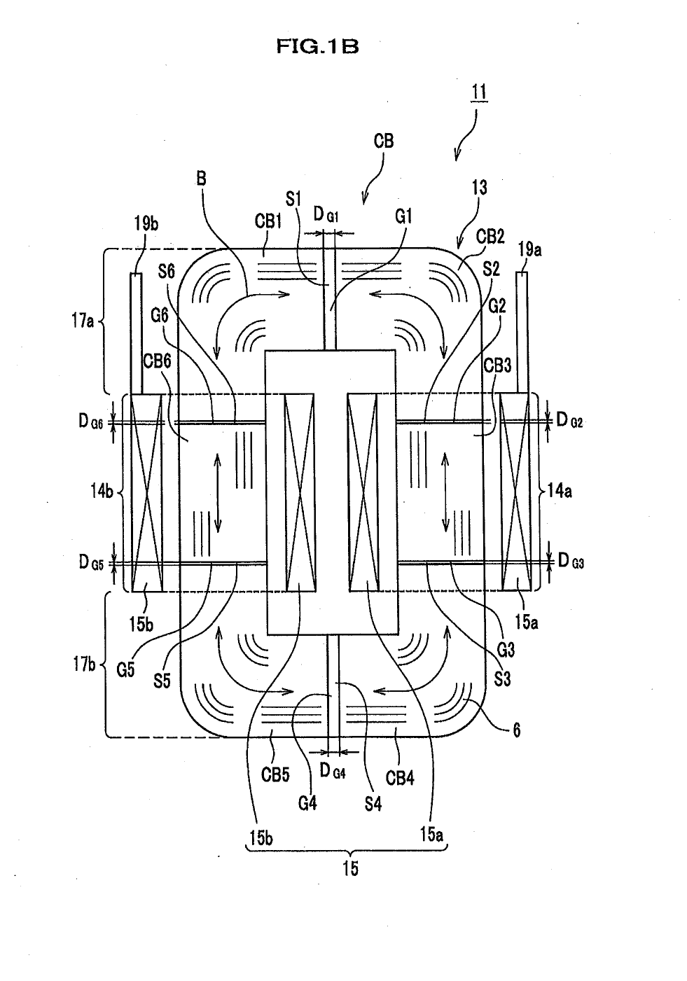

Next, will be described a reactor 21 according to a second embodiment of the present invention. FIG. 2 is a front section view of the reactor 21 according to the second embodiment of the present invention. The reactor 21 has substantially the same configuration as the reactor 11 according to the first embodiment. The same components in the second embodiment as those in the first embodiment are designated with the same or like references and a duplicated description will be omitted.

There is a difference between the first and the second embodiment as follows:

Here, positions of the gaps G1 to G6 are expressed using a clock face notation similarly to the first embodiment. The first gap G1 in the first yoke portion 17a is located at a position of 12 o'clock and the forth gap G4 is located at a position of 6 o'clock.

On the other hand, in the reactor 21 according to the second embodiment, a seventh and tenth gaps G7 and G10 are formed in the first yoke portion 17a and eighth and ninth gap G8, G9 are formed in the second yoke portion 17b, and thus four gaps are formed in total. In addition, the seventh gap G7 is located at a position of 2 o'clock in the clock face notation described in the first embodiment; the eighth gap G8, at 4 o'clock; the ninth gap G9, at 8 o'clock, and the tenth gap G10, at 10 o'clock.

The reactor 21 according to the second embodiment is different in that the number of the gaps and positions in the first and second yoke portions 17a, 17b from the reactor 11 according to the first embodiment. The reactor 21 according to the second embodiment is formed by connecting eight core blocks CB21 to CB28. The second and third, fifth to sixth magnetic leg gap lengths D_{G2}, D_{G3}, D_{G5}, D_{G6} are the same as those in the reactor 11 according to the first embodiment.

Here, assumption will be made for simplified description of the reactor 21 as follows:

As shown in FIG. 2, a length of a seventh gap G7 in the first yoke portion 17a between twenty-first and twenty-second core blocks CB21, CB22 facing each other is referred to as a seventh yoke portion gap length D_{G7}. A length of a tenth gap G10 in the first yoke portion 17a between 28-th and 21-th core blocks CB28, CB21 facing each other is referred to as a tenth yoke portion gap length D_{G10}. A length of an eighth gap G8 in the second yoke portion 17b between 24-th and 25-th core blocks CB24, CB25 facing each other is referred to as an eighth yoke portion gap length D_{G8}. A length of a ninth gap G9 in the second yoke portion 17b between 25-th and 26-th core blocks CB25, CB26 facing each other is referred to as a ninth yoke portion gap length D_{G9}.

The seventh to tenth gap lengths D_{G7} to D_{G10} according to the second embodiment are set to substantially the same value as the first and the fourth yoke portion gap lengths D_{G1}, D_{G4} according to the first embodiment. In addition, the reactor 21 according to the second embodiment can be manufactured by a process similar to that for the reactor 11 according to the first embodiment.

In the reactor 21 according to the second embodiment, the second, third, fifth, sixth magnetic leg portion gap lengths D_{G2}, D_{G3}, D_{G5}, D_{G6} are set to a smaller value than the seventh to tenth yoke portion gap length D_{G7} to D_{G10}, the loss in the reactor 21 caused by leakage of the magnetic flux (gap loss) from the second, third, fifth, sixth gaps G2, G3, G5, G6 in the first or second magnetic leg portion 14a or 14b in which a total gap length is kept as a whole of a ringed core 23 similar to the reactor 11 according to the first embodiment. Accordingly, the reactor 21 for a single-phase use can be provided in which the loss as a whole is suppressed.

In the reactor 21 according to the second embodiment, a total length of the seventh to tenth yoke portion gap lengths D_{G7} to D_{G10} in the first and second yoke portions 17a, 17b is set to a value which is approximately twice the total gap length of the first and second yoke portion gap lengths D_{G1}, D_{G4} according to the first embodiment. The reactor 21 according to the second embodiment is more preferable for a lager power use than the reactor 11 according to the first embodiment because of increased degree of freedom for a large power use. This is because in the reactor 21, a total gap length as a whole of the ringed core 23 can be more largely provided than the reactor 11 according to the first embodiment.

### Third Embodiment

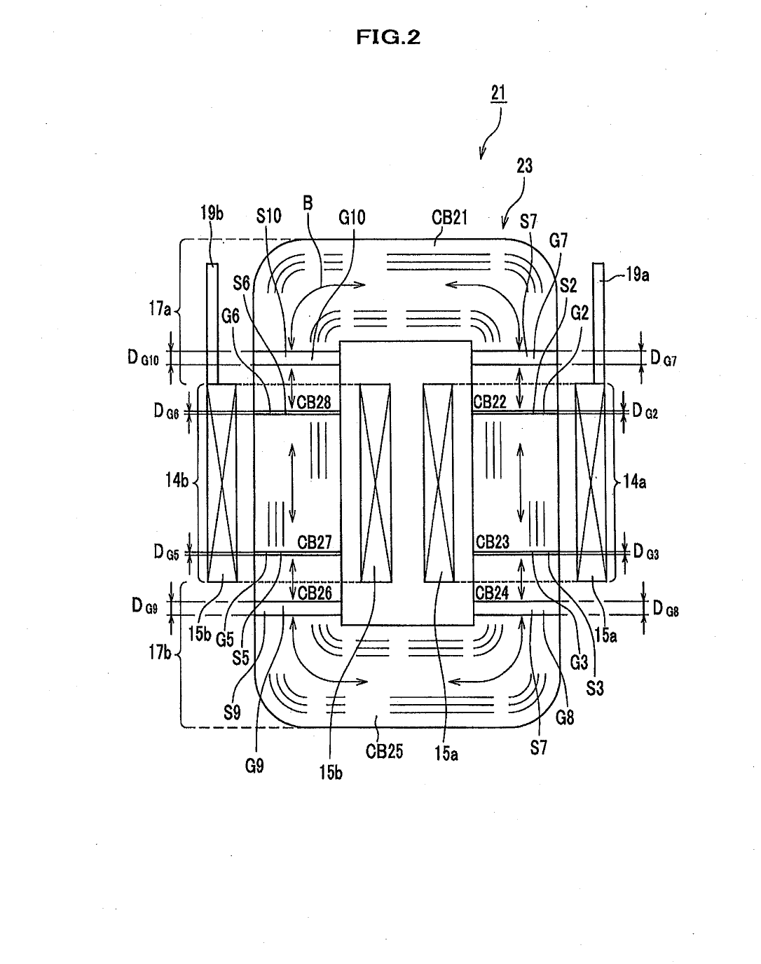

Next, will be described a reactor 31 according to a third embodiment of the present invention. FIG. 3 is a front section view of the reactor 31 according to the third embodiment of the present invention. The reactor 31 has substantially the same configuration as the reactor 11 according to the first embodiment. The same components in the third embodiment as those in the first embodiment are designated with the same or like reference and a duplicated description will be omitted.

There is a difference between the first and the third embodiments as follows:

In the reactor 11 according to the first embodiment, the first and second yoke portions 17a, 17b are vertically, in FIG. 1B, divided into two parts across the first and second magnetic leg portions 14a, 14b.

Positions of the second and third gaps G1 to G6 are expressed using a clock face notation. The second and third gap G2, G3 are located at positions just after and before 3 o'clock with an interval, and the fifth and sixth gaps G5 and G6 are located at positions just after and before 9 o'clock with an interval. The first gap G1 in the first yoke portion 17a is formed at the position of 12 o'clock, and the second gap G4 in the second yoke portion 17a is formed at the position of 6 o'clock, respectively.

On the other hand, in the reactor 31 according to the third embodiment, the number of a magnetic excitation coil 35, the second magnetic leg portion 14b, and a yoke portion 37 each are only one. One yoke portion 37 is formed continuously in a C-shape in FIG. 3 wherein a magnetic leg portion (second magnetic leg portion) 14b is interposed between both ends of the yoke portion 37. In addition, as shown in FIG. 3, two gaps, i.e., fifth and sixth gaps G5 and G6, in one magnetic leg portion 14b are formed at positions just before and after 9 o'clock with an interval. This point is similar to the reactor 11 according to the first embodiment. However, in the reactor 31 according to the third embodiment is different from the reactor 11 according to the first embodiment in that the first magnetic leg portion 14a is omitted. In one yoke portion 37, the reactor 31 and 32 the gaps G31, G32 are formed at position just before and after 3 o'clock.

The reactor 31 according to the third embodiment is largely different from the reactor 11 according to the first embodiment in that the number of the magnetic excitation coil 35, and the number of and locations of the gaps and the second magnetic leg portion 14b or the yoke portion 37. In the reactor 31 according to the third embodiment, four of, in total, thirty-first to thirty-fourth core blocks CB31 to CB34 are assembled and connected.

Here, assumption will be made for simplified description of the reactor 31 as follows:

As shown in FIG. 3, a length of a 31-th gap G31 in the yoke portion 37 between 31-th and 32-th core blocks CB31, CB32 facing each other is referred to as a 31-th yoke portion gap portion length D_{G31}. A length of a 32-th gap G32 in the yoke portion 37 between 32-th and 33-th core blocks CB32, CB33 facing each other is referred to as a thirty-second yoke portion gap length D_{G32}.

The 31-th and the 32-th yoke portion gap length D_{G31} and D_{G32} according to the third embodiment are set to substantially the same value as the first and the fourth yoke portion gap lengths DG1, DG4 according to the first embodiment. In addition, the reactor 31 according to the third embodiment can be manufactured by a process similar to that for the reactor 11 according to the first embodiment.

The reactor 21 according to the third embodiment, as similar to the reactor 11 according to the first embodiment, the loss in the reactor 31 caused by leakage of the magnetic flux (gap loss) from the fifth, sixth gaps G5, G6 in the fifth and sixth magnetic leg portion in which a total gap length is kept as a whole of a ringed core 33 similar to the reactor 11 according to the first embodiment. Accordingly, the reactor 31 for a single-phase use can be provided with the loss as a whole is suppressed.

### Fourth Embodiment

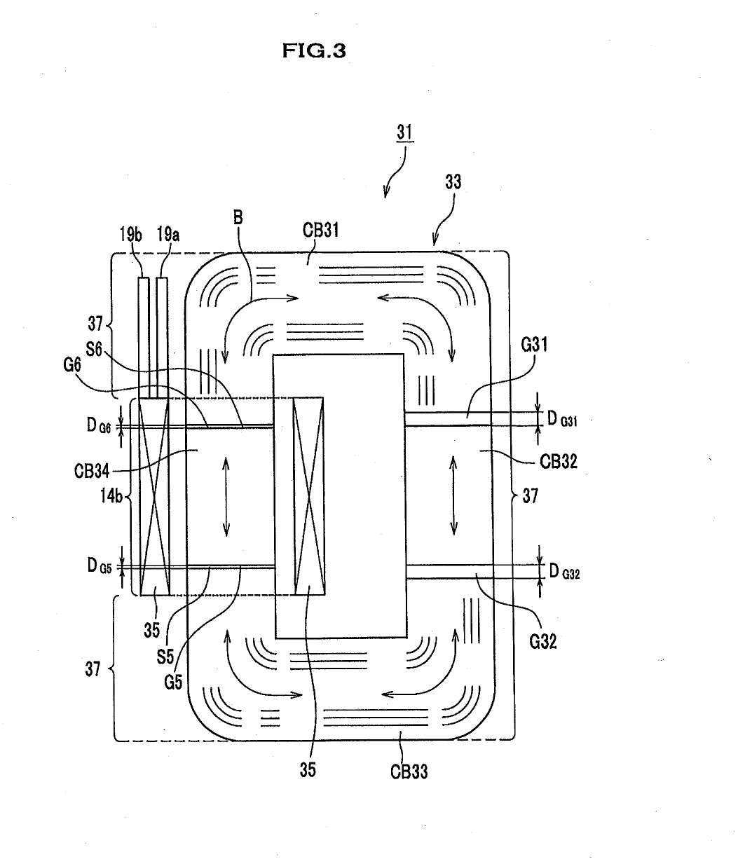

With reference to drawing will be described a reactor 41 according to a fourth embodiment. FIG. 4 is a front section view of the reactor 41 according to the fourth embodiment of the present invention. A reactor 41 according to the fourth embodiment provides a three-phase reactor 41 in which two ringed cores 43-1, 43-2 are disposed in parallel each other, which has the same configuration as the ringed core 13 of the reactor 11 according to the first embodiment. Adjoining magnetic leg portions 14b-1, 14a-2 are magnetically coupled with a magnetic excitation coil 45b shared therebetween. Accordingly, three sets of magnetic leg portions, i.e., the magnetic leg portion 14a-1, a pair of magnetic leg portions 14b-1 and 14a2, and the magnetic leg portion 14b-2 are provided to form a three-phase reactor 41. The magnetic excitation coil 45a is wound around the magnetic leg portion 14a-1 of one ringed core 43-1, and the magnetic excitation coil 45c is wound around the magnetic leg portion 14b-1 of the other ringed core 43-2, respectively.

These three magnetic excitation coils 45a, 45b, 45c are used as three phase coils for U-phase, V-phase, and W-phase respectively to provide a three-phase reactor 41. In addition to three magnetic leg portions three sets of magnetic leg portions, i.e., the magnetic leg portion 14a-1, a pair of magnetic leg portions 14b-1 and 14-2, and the magnetic leg portion 14b-2, zero-phase impedance magnetic legs (having different concept from the magnetic leg portion) may be provided on both sides of each set.

Because other configuration is basically the same as the ringed core 13 of the reactor 11 according to the first embodiment basically, the duplication description will be omitted. In FIG. 4, a part of electrodes are omitted for the set of a magnetic leg portions 14b-1, 14a-2. In addition, in the reactor 41 according to the fourth embodiment, parts commonly used in the first embodiment are designated with like references. More specifically, to identify the parts in the fourth embodiment from those in the first embodiment, an additional reference of “−1” is added to the common reference of one embodiment, and an additional reference of “−2” is added to the common reference of the other embodiment.

The reactor 41 according to the fourth embodiment can be manufactured by the process similar to that for the reactor 11 according to the first embodiment.

Like the reactor 11 according to the first embodiment, the reactor 41 according to the fourth embodiment can suppress the loss in the reactor 41 caused by leakage from the gaps G2-1, G3-1, G5-1, G6-1, G2-2, G3-2, G5-2, G6-2 in three sets of magnetic leg portions 14a-1, the pair of magnetic leg portions 14b-1 and 14a-2, and the magnetic leg portion 14b-2 in which a total gap length as a whole of the ringed cores 43-1, 43-2 is kept. Accordingly, the reactor 41 for a three-phase use can be provided in which the loss as a whole is suppressed.

### Fifth Embodiment

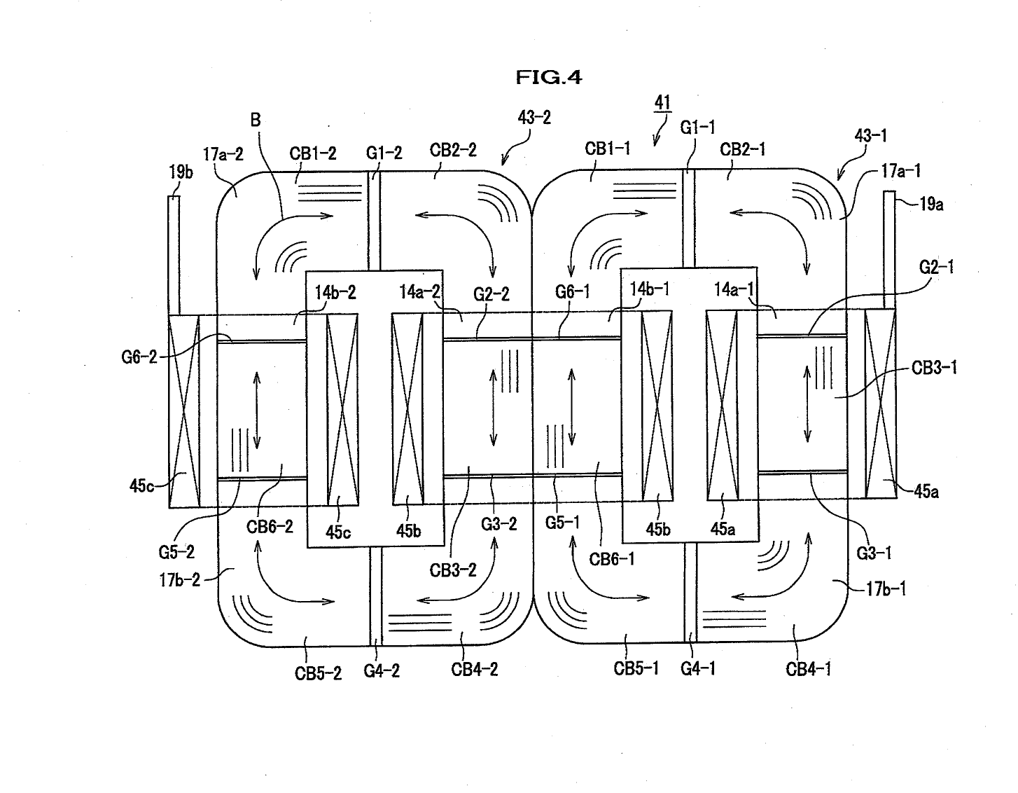

With reference to drawing will be described a fixing structure for the reactor 11 according to a fifth embodiment. FIG. 5 is a front section view of the reactor 41 according to the fourth embodiment of the present invention. The fixing structure for the reactor 11 according to the fifth embodiment is shown in FIG. 5 in which the reactor 11 according to the first embodiment is fixed to a base 51.

The fixing structure for the reactor 11 according to the fifth embodiment is an example showing how to fix the reactor 11 according to the first embodiment to the base 51 in which the reactor 11 is used as it is. Accordingly, a duplicated description about the reactor 11 according to the first embodiment will be omitted, and the fixing structure will be described mainly.

The ringed core 13 for the reactor 11 according to the fifth (first embodiment) is manufactured by the following process. First, the first to sixth core blocks CB1 to CB6 and the first to sixth gap spacers S1 to S6 to have a predetermined positional relation. While this status is kept, a fixing band 53 is wound around an outer circumference of the core blocks CB1 to CB6. After that, the fixing band 53 is fastened by a fastening member such as a fastening screw 55, etc. The ringed core 13 for the reactor 11 according to the first embodiment is fixed as an integral body by the above-described process.

During fixing, an insulation member having a sleeve shape may intervene between an outer circumference and an inner circumferences of the first and second magnetic excitation coils 15a, 15b to keep a predetermined gap (generally, a length from twice to three-times the gap length). The ringed core 13 is fastened and fixed as described above, and while this arrangement of the ringed core 13 on the base 51 is kept, the ringed core 13 is fixed to the base 51 integrally with a first magnetic excitation coil 15a and a second magnetic excitation coil 15b by a fixing jig 57.

The fixing structure of the reactor 11 according to the fifth embodiment provides how to fix the reactor 11 according to the first embodiment to the base 51 in which the reactor 11 is used as it is.

### Sixth Embodiment

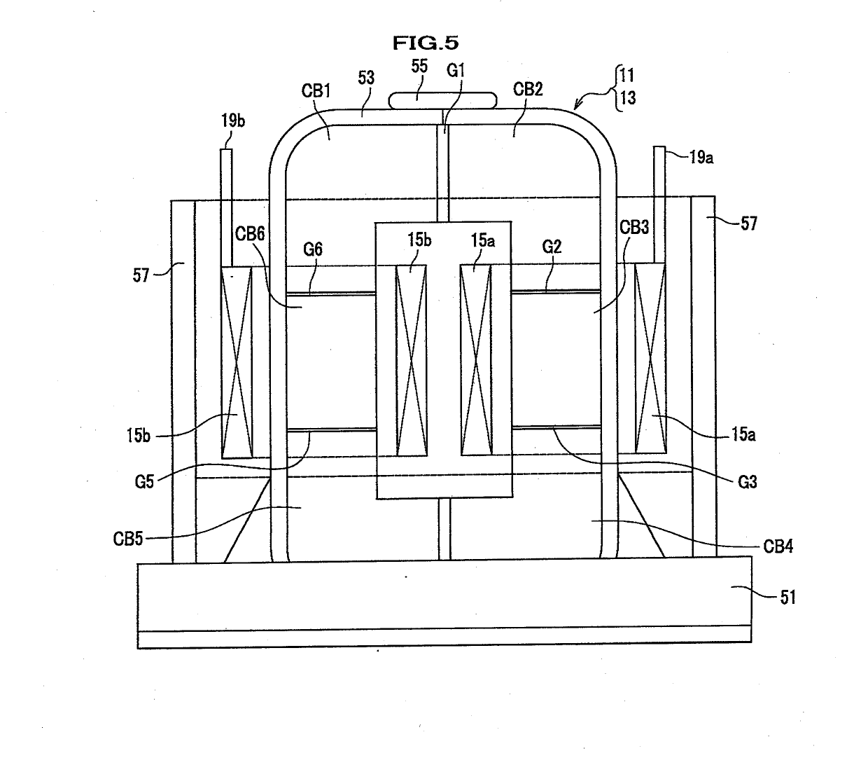

Next, will be described a power converter 61 according to a sixth embodiment of the present invention. FIG. 6 is a schematic circuit diagram of a power converter 61 according to the sixth embodiment of the present invention. The power converter 61 according to the sixth embodiment is provided by building the reactor 11 according to the first embodiment in the power converter 61 as an element of the power converter 61.

The power converter 61 according to the sixth embodiment includes a fitter circuit 66 connected to a single-phase AC power source 63, and a power converting unit 67. The filter includes the reactor 11 according to the first embodiment (second or third embodiment) and a capacitor connected to the reactor 11. The power converting unit 67 includes first to fourth switching elements (for example, semiconductor devices such as IGBT) 67a to 67d for power-converting an output of the filter circuit 66 in accordance with a PWM (pulse width modulation) control signal from a controller (not shown).

The power converter 61 according to the sixth embodiment converts the single-phase AC power from the AC power source 63 to a single-phase AC power having a given frequency and given amplitude. During this power conversion, the filter circuit 66 filters out harmonic currents accompanied by the PWM control of the first to fourth switching elements 67a to 67d. This filtration is carried out using the reactor 11 according to the first embodiment in which the loss is suppressed. Accordingly, in the power converter 61 according to the sixth embodiment, harmonic currents in the AC power source 63 can be appropriately reduced. The power converter 61 according to the sixth embodiment can provide the power converter 61 having a low transmission loss and a high efficiency.

### Seventh Embodiment

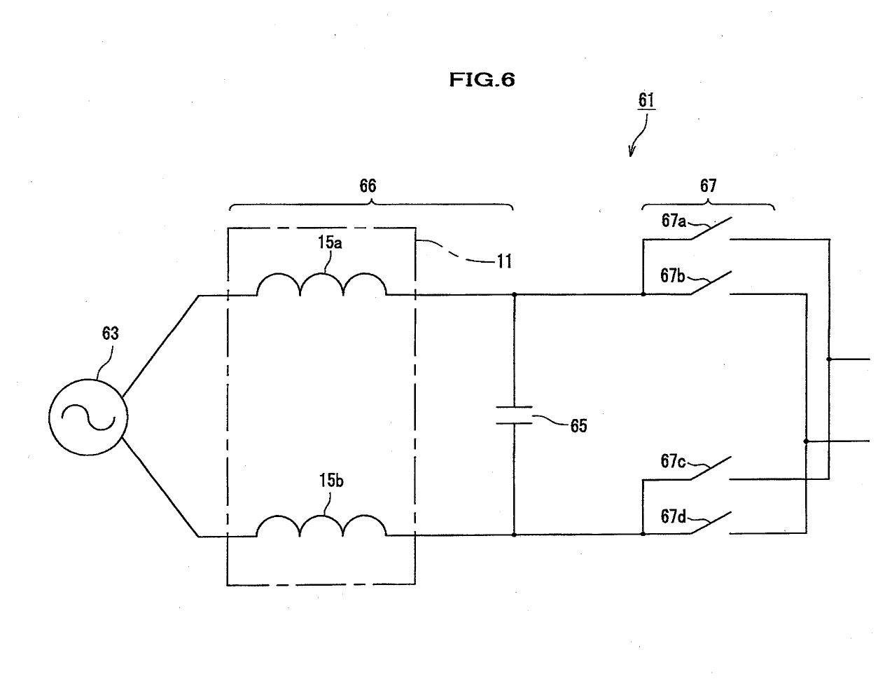

Next, will be described a power converter 71 according to a seventh embodiment of the present invention using the reactor 41. FIG. 7 is a schematic circuit diagram of a power converter 71 according to the seventh embodiment of the present invention. The power converter 71 according to the seventh embodiment is provided by assembling the reactor 41 according to the fourth embodiment in the power converter 71 as an element of the power converter 61.

The power converter 71 according to the seventh embodiment includes a filter circuit 74 connected to a three-phase AC power source 73, and a power converting unit 78. The filter circuit 74 includes the reactor 41 according to the fourth embodiment and capacitors 75, 76, 77 connected to the reactor 11. The power converting unit 78 includes eleventh to nineteenth switching elements (for example, semiconductor devices such as IGBT) 78a to 78i for power-converting an output of the filter circuit 74 in accordance with a PWM (pulse width modulation) control signal from a controller (not shown).

The power converter 71 according to the seventh embodiment converts the three-phase AC power from the AC power source 73 to a three-phase AC power having a given frequency and a given amplitude. During this power conversion, the filter circuit 74 filters out harmonic currents accompanied by the PWM control of the eleventh to nineteenth switching elements 78a to 78i. This filtration is carried out using the reactor 41 according to the fourth embodiment in which the loss is suppressed. Accordingly, in the power converter 71 according to the sixth embodiment, harmonic currents in the AC power source 73 can be appropriately reduced. The power converter 71 according to the seventh embodiment can provide the power converter 71 having a low transmission loss and a high efficiency.

### Other Embodiments

The above-described embodiments are examples of the present invention. Thus, the present invention is not limited to the above-described embodiments, and may be modified.

For example, in the ringed core 13 of the reactor 11 according to the first embodiment, a pair of the magnetic lag portions 14a and 14b are disposed at such locations that the first magnetic leg portion 14a and 14b face each other. However, the present invention is not limited to this. A pair of the first magnetic leg portion 14a and the second magnetic leg portion 14b may be disposed at such positions that the first magnetic leg portion 14a and the second magnetic leg portion 14b are orthogonal with each other or may be disposed to have a given angle made there between. In addition, the number of the magnetic leg portions is not limited to two. As shown in the reactor 31 according to the third embodiment, one, three, four, or more magnetic leg portions may provided in one ring core.

In addition, in the ringed core 13 of the reactor 11 according to the first embodiment, two gaps, i.e., the second and third gap G2 and G3 are formed in the first magnetic leg portion 14a, and two gaps, i.e., the fifth and sixth gap G5 and G6 are formed in the second magnetic leg portion 14b, are formed, i.e., four gaps in total are formed. However, the present invention is not limited to this. One gap may be formed or more than two gaps may be formed in the first magnetic leg portion 14a. Similarly, one gap may be formed or more than two gaps may be formed in the second magnetic leg portion 14b.

In addition, positions of the second and third gaps G2 and G3 are expressed using the clock face notation. The second and third gap G2, G3 are located at positions just after and before 3 o'clock with an interval and the fifth and sixth gaps G5 and G6 are located at positions just after and before 9 o'clock with an interval. However, the present invention is not limited to this. The positions of the gaps in the magnetic leg portion can be appropriately set to satisfy characteristics to be inherently provided in the reactor.

In addition, the first embodiment has been described with the example in which two gaps in total, i.e., the first gap G1 in the first yoke portion 17a, and the gap G4 in the second yoke portion 17b, are provided. However, the present invention is not limited to this example. The number of the gaps in the yoke portion may be any number equal to or more than one. For example, as shown in the reactor 21 according to the second embodiment, four gaps in total may be provided, i.e., the seventh and tenth gaps G7 and G10 are provided in the first yoke portion 17a, and the eighth and ninth gaps G8 and G9 are provided in the second yoke portion 17b.

Here, in the ringed core 13 of the reactor 11 according to the first embodiment, positions of the gaps are expressed using a clock face notation. The first gap G1 in the first yoke portion 17a is located at a position of 12 o'clock and the fourth gap G4 is located at a position of 6 o'clock. However, the present invention is not limited to this example. The positions of the gaps in the yoke portion can be appropriately set so as to satisfy characteristics to be inherently provided in the reactor or in accordance with convenience of manufacturing.

In the first embodiment of the present invention, the second or the third magnetic leg portion gap length DG2 or DG3 is set to be smaller than the first or fourth yoke portion gap length DG1 or DG4. As well as, the fifth or the sixth magnetic leg portion gap length DG2 or DG3 is set to be smaller than the first or fourth yoke portion gap length DG1 or DG4. However, the present invention is not limited to this example. A total of the magnetic leg portion gap length in a case where a plurality of gaps are formed in the magnetic leg portion may be set to be smaller than a total of the yoke portion gap lengths in a case where a plurality of gaps are formed in the yoke portion. When such a configuration is adopted, an advantageous effect may be provided similarly to the first embodiment.

In addition, a total of the magnetic leg portion gap length when a plurality of the gaps are formed in the magnetic leg portion may be set to be smaller than the yoke portion gap length (the yoke portion gap length of one of the gaps existing in the yoke portion. When such configuration is adopted, such configuration provides the same operation as the first embodiment.

As the reactor 41 according to the fourth embodiment, i.e., a three-phase reactor 41, two ringed cores 43-1, 43-2 are disposed in parallel each other, which has the same configuration as the ringed core 13 of the reactor 11 according to the first embodiment. Adjoining magnetic leg portions 14b-1, 14a-2 are magnetically coupled with a common magnetic excitation coil 45b. Accordingly, three sets of magnetic leg portions, i.e., the magnetic leg portion 14a-1, a pair of magnetic leg portions 14b-1 and 14a2, and the magnetic leg portion 14b-2 are provided to form a three-phase reactor 41. However, the present invention is not limited to this example. As the reactor 41 according to the fourth embodiment, i.e., a three-phase reactor 41 may be provided in which two ringed cores having the same configuration as the ringed core 23 of the reactor 21 according to the second embodiment are disposed in parallel each other, which has the same configuration as the ringed core 23 of the reactor 21 according to the second embodiment. Adjoining magnetic leg portions are magnetically coupled with a shared magnetic excitation coil. Accordingly, three sets of magnetic leg portions are provided to form a three-phase reactor. When such configuration is adopted, the same operation as the fourth embodiment is kept.

In the reactors 11, 21, 31, and 41 according to the first to fourth embodiments, the magnetic excitation coils are exemplified which have the same length in a direction along the magnetic flux direction B. However, the present invention is not limited to this example. Magnetic excitation coils having a length which is different from a common length in the direction may be used in the reactors 11, 21, 31, and 41.

In addition, as the fixing structure for the rector apparatus 11 according to the fifth embodiment, an example was made for description in which how to fix to the base 1 the reactor 11 according to the first embodiment which is used as it is. However, the present invention is not limited to this. In place of the reactor 11 according to the first embodiment, the fixing structure for the reactor according to the fifth embodiment can be provided by using any one of the reactor 21 according to the second embodiment, the reactor 31 according to the third embodiment, and the reactor 41 according to the fourth embodiment.

In addition, an example has been described above in which the reactor 11 is assembled in the power converter 61 according to the sixth embodiment as a structural element. However, the present invention is not limited to this. In place of the reactor 11 according to the first embodiment, either of the reactor 21 according to the second embodiment or the reactor 31 according to the third embodiment may be assembled as a structural element of the power converter according to the sixth embodiment.

In addition, an example has been described above in which the reactor 41 is assembled in the power converter 71 according to the seventh embodiment as a structural element. However, the present invention is not limited to this. A thee-phase reactor may be assembled in the power converter according to the seventh embodiment, the three-phase reactor being configured by disposing two ringed cores having the same configuration as the ringed core 23 of the reactor 21 according to the second embodiment in parallel, and magnetically coupling adjoining magnetic legs each other with a common magnetic excitation coil to provides three sets of magnetic leg portions.

The power converter 61 according to the sixth embodiment or the power converter 71 according to the seventh embodiment may be assembled in an uninterruptible power supply. This configuration provides a high efficiency uninterruptible power supply with a low conversion loss.

According to the present invention, even if a gap is formed in a region of the ringed core where the magnetic excitation coil is wound, a reactor capable of suppressing the loss caused by leakage of the magnetic flux from the gap can be provided.

As described above, the present invention provides the reactor including: a ringed core including a plurality of core blocks made of a magnetic material, the core blocks being connected in a ring through gaps (with gaps); a magnetic excitation coil wound around the ringed core. The ringed core includes a magnetic leg region around which the magnetic excitation coil is wound and a yoke portion region where the magnetic excitation coil is not wound. A length of the gap between end faces of adjoining core blocks in the magnetic leg region is smaller than a length of the gap between end faces of adjoining core blocks in the yoke portion region.

In addition, the gap in the magnetic region may include a plurality of gaps, and the gap in the yoke portion region may include a plurality of gaps in the yoke portion region. A total length of the gaps in the magnetic leg region is smaller than a total length of the gaps in the yoke portion region.

In addition, the gap in the magnetic region may include a plurality of gaps. A total length of the gaps in the magnetic leg region may be smaller than the length of the gap in the yoke portion region.

The invention claimed is:

1. A reactor comprising:
a ringed core including a plurality of core blocks made of a magnetic material, the core blocks being connected in a ring through gaps;
a magnetic excitation coil wound around the ringed core, wherein
the ringed core comprises a magnetic leg region around which the magnetic excitation coil is wound and a yoke portion region where the magnetic excitation coil is not wound, and wherein
a length of the gap between end faces of adjoining core blocks in the magnetic leg region is smaller than a length of the gap between end faces of adjoining core blocks in the yoke portion region.

2. The reactor as claimed in claim 1, wherein
the gap in the magnetic region comprises a plurality of gaps, and the gap in the yoke portion region comprises a plurality of gaps in the yoke portion region, and wherein
a total length of the gaps in the magnetic leg region is smaller than a total length of the gaps in the yoke portion region.

3. The reactor as claimed in claim 1, wherein the gap in the magnetic region comprises a plurality of gaps, wherein a total length of the gaps in the magnetic leg region is smaller than the length of the gap in the yoke portion region.

4. The reactor as claimed in claim 1, further comprising a gap spacer in the gap in at least one of the magnetic leg region and the yoke portion region, wherein the gap spacer is made of a non-magnetic material.

5. The reactor as claimed in claim 1, wherein the magnetic excitation coil comprises either of a wire conductor or a stripe plate conductor and an insulator on the wire conductor or the stripe plate conductor.

6. The reactor as claimed in claim 1, wherein the annular magnetic core comprises a plurality of thin film conductors, laminated, having a soft magnetic characteristic.

7. The reactor as claimed in claim 1, wherein the ringed core comprises an isotropic material.

8. A power converter comprising:
a filter circuit connected to an AC power source, the filter circuit including the reactor as claimed in claim 1 and a capacitor; and
a switching circuit configured to perform switching of an output of the filter circuit to generate a power conversion output.
